(19) United States
(12) Patent Application Publication
(10) Pub. No.: US 2021/0003399 A1
(43) Pub. Date: Jan. 7, 2021

(54) INFORMATION GENERATING APPARATUS AND METHOD OF CONTROLLING THE SAME

(71) Applicant: HONDA MOTOR CO., LTD., Tokyo (JP)

(72) Inventors: Manabu Dobashi, Wako-shi (JP); Koji Kuriyagawa, Wako-shi (JP); Hiroshi Yamakawa, Wako-shi (JP)

(73) Assignee: HONDA MOTOR CO., LTD., Tokyo (JP)

(21) Appl. No.: 17/026,590

(22) Filed: Sep. 21, 2020

Related U.S. Application Data
(63) Continuation of application No. PCT/JP2018/011835, filed on Mar. 23, 2018.

(51) Int. Cl. G01C 21/20; G05D 1/02; G07C 5/00; G07C 5/08

(52) U.S. Cl. CPC G01C 21/20; G05D 1/0212; G05D 1/0291; G05D 2201/0208; G07C 5/006; G07C 5/0808; G05D 1/0206

(57) ABSTRACT

An information generating apparatus obtains usage state information about mobile bodies from the mobile bodies and maintenance information about the mobile bodies. The information generation apparatus estimates a maintenance time for each mobile body based on the usage state information and the maintenance information, determines, based on locations of the mobile bodies and the maintenance time estimated for each mobile body, a route by which a maintenance worker of the mobile bodies visits the locations of the mobile bodies, and generates route information including the route determined. The information generating apparatus specifies the mobile bodies of which the worker visits the locations based on whether the maintenance time estimated is within a first period.

### CROSS-REFERENCE TO RELATED APPLICATION

This application is a continuation of International Patent Application No. PCT/JP2018/011835 filed on Mar. 23, 2018, the entire disclosures of which is incorporated herein by reference.

### BACKGROUND OF THE INVENTION

### Field of the Invention

The present invention relates to an information generating apparatus and a method of controlling the same.

### Description of the Related Art

Techniques have been known in which a server receives information, such as driving data and failure information about an industrial vehicle such as a forklift, and if the failure probability of the industrial vehicle is found to be above a predetermined value according to the received information, the server transmits warning information to the industrial vehicle (Patent Literature 1).

Patent Literature 1 discloses a technique of determining a failure probability based on: driving data such as the mileage of an industrial vehicle; failure information indicating information such as the failure part and the mileage related to the failure; repair data; and abnormality information about a detected abnormal driving state of the industrial vehicle. According to the technique described in Patent Literature 1, the user of an industrial vehicle who is driving with a high failure probability can be warned about the user's driving.

### CITATION LIST

### Patent Literature

Patent Literature 1 Japanese Patent Laid-Open No. 2013-156864

The technique described in Patent Literature 1 relates to providing information about appropriate use of mobile bodies (including mobile bodies other than industrial vehicles as mentioned above) to the users of the mobile bodies based on failure and repair information. In this regard, it may be beneficial to enable a worker responsible for the maintenance of the mobile bodies (also simply referred to as a maintenance worker) to perform the maintenance of the mobile bodies at an appropriate time before the occurrence of a failure. For example, it is expected that more efficient maintenance services will be provided if the maintenance worker can visit the locations of the mobile bodies at an appropriate maintenance time.

The present invention has been made in view of the above, and an object thereof is to provide a technique that enables generating information with which a worker responsible for maintenance work can more efficiently visit the locations of mobile bodies.

### SUMMARY OF THE INVENTION

According to the present invention, an information generating apparatus is provided. The apparatus includes: one or more processors; and a memory storing instructions which, when the instructions are executed by the one or more processors, cause the image processing apparatus to function as: a usage state obtaining unit configured to obtain usage state information about mobile bodies from the mobile bodies; a maintenance information obtaining unit configured to obtain maintenance information about the mobile bodies; an estimating unit configured to estimate a maintenance time for each mobile body based on the usage state information and the maintenance information; a determining unit configured to determine, based on locations of the mobile bodies and the maintenance time estimated for each mobile body, a route by which a worker responsible for maintenance of the mobile bodies visits the locations of the mobile bodies; and a generating unit configured to generate route information including the route determined, wherein the determining unit specifies the mobile bodies of which the worker visits the locations based on whether the maintenance time estimated is within a first period.

According to the present invention, a method of controlling an information generating apparatus is also provided. The method includes: obtaining, by a usage state obtaining unit, usage state information about mobile bodies from the mobile bodies; obtaining, by a maintenance information obtaining unit, maintenance information about the mobile bodies; estimating, by an estimating unit, a maintenance time for each mobile body based on the usage state information and the maintenance information; determining, by a determining unit, based on locations of the mobile bodies and the maintenance time estimated for each mobile body, a route by which a worker responsible for maintenance of the mobile bodies visits the locations of the mobile bodies; and generating, by a generating unit, route information including the route determined, wherein the determining the route comprises specifying the mobile bodies of which the worker visits the locations based on whether the maintenance time estimated is within a first period.

According to the present invention, information for a worker responsible for maintenance work to more efficiently visit the locations of mobile bodies can be generated.

Other features and advantages of the present invention will become apparent from the following description with reference to the accompanying drawings. In the accompanying drawings, like or similar elements are given like reference numerals.

### BRIEF DESCRIPTION OF THE DRAWINGS

The accompanying drawings, which are included in and constitute part of the specification, are used for showing an embodiment of the present invention and for illustrating the principle of the present invention in combination with the description of the present invention.

FIG. 1 is a diagram showing an exemplary system configuration of an information generating system according to an embodiment;

FIG. 2 is a block diagram showing an exemplary functional configuration of a mobile body according to the embodiment;

FIG. 3 is a block diagram showing an exemplary functional configuration of an information generating server according to the embodiment;

FIG. 4 is a block diagram showing an exemplary functional configuration of a maintenance terminal used by a maintenance worker according to the embodiment;

FIG. 5 is a flowchart describing the operations of the process of providing mobile body information in the mobile body according to the embodiment;

FIG. 6 is a flowchart showing the operations of the process of obtaining the mobile body information in the information generating server according to the embodiment;

FIG. 7 is a flowchart showing the operations of the process of generating route information in the information generating server according to the embodiment;

FIG. 8 is a flowchart showing the operations of the process of presenting the route information in the maintenance terminal according to the embodiment;

FIG. 9 is a diagram showing an exemplary table that stores usage state information and maintenance information about mobile bodies according to the embodiment; and

FIG. 10 is a diagram schematically showing an exemplary route by which a maintenance worker visits the locations of mobile bodies according to the embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made an invention that requires a combination of all features described in the embodiments. Two or more of the multiple features described in the embodiments may be combined as appropriate. Furthermore, the same reference numerals are given to the same or similar configurations, and redundant description thereof is omitted.

An exemplary embodiment of the present invention will be described in detail below with reference to the drawings.

<Configuration of Information Generating System>

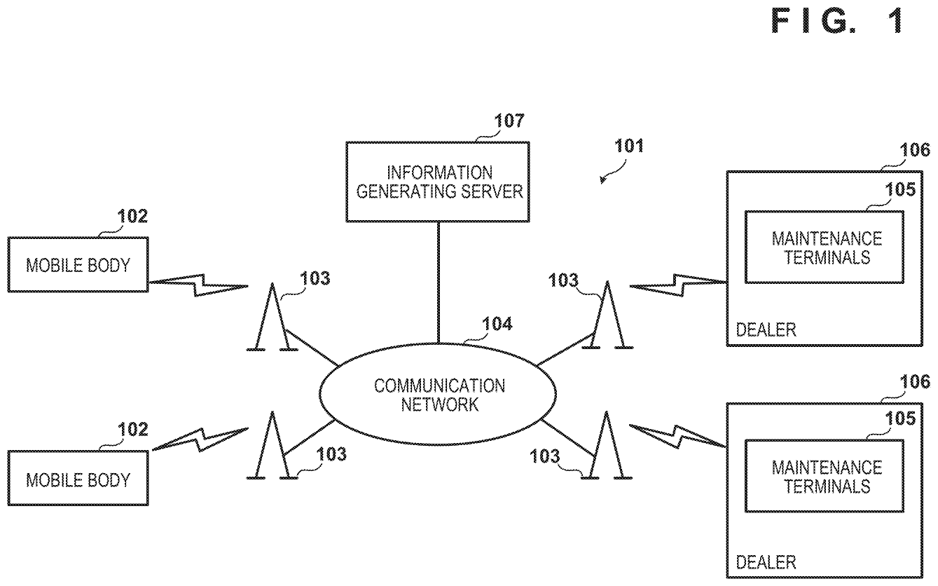

An information generating system 101 according to this embodiment will be described with reference to FIG. 1. Mobile bodies 102 include working machines such as lawn mowers and snowplows, or ships, for example. In this embodiment, lawn mowers, as well as boats equipped with outboard motors (hereafter simply referred to as outboard motors), will be described as exemplary mobile bodies. However, the mobile bodies may be of other types, including two-wheel or four-wheel vehicles. Rather than those that operate while travelling, the mobile bodies may be those carried by users. For example, the mobile bodies may be those that stay in place while operating, such as general-purpose engines and water pumps. Each mobile body 102 may be able to travel by means of a power generator (not shown). While travelling, for example, each mobile body 102 transmits information obtained therein (e.g., usage state information and location information to be described below) to an information generating server 107 via a communication unit 206 to be described below. The mobile bodies 102 are of different types, for example lawn mower and outboard motor, and each type includes multiple mobile bodies. The mobile bodies 102 are sold to owners via dealers 106. For example, a lawn mower sold is used by a user (or an owner) at a certain location, and as necessary, placed at a storage location managed by the user or owner when not used. That is, the mobile bodies 102 are located at different locations and at different distances from their respective dealers 106.

Wireless communication base stations 103 communicate with a communication unit 206 (to be described below) of each mobile body 102 according to a standard, for example LTE-Advanced, thereby transferring information from the mobile body 102 to a communication network 104.

The communication network 104 includes communication networks such as the Internet and a mobile telephone network, for example. The communication network 104 transfers information between maintenance terminals 105 connected to the communication network 104 and the information generating server 107, or between the mobile bodies 102 and the information generating server 107.

Each dealer 106 is, for example, a shop operated by an entity that sells mobile bodies 102 and that is responsible for the maintenance of the mobile bodies 102 (hereafter simply referred to as a maintenance worker). The maintenance worker visits the locations of mobile bodies to perform the maintenance of the mobile bodies as will be described below, and also perform, at the shop, the maintenance of mobile bodies brought in by the owners. When the maintenance worker performs the maintenance of a mobile body, the maintenance worker records information, for example the maintenance date and time and maintenance details (to be described in detail below), in the worker's maintenance terminal 105. The information recorded in the maintenance terminal 105 is then transmitted as maintenance information (i.e., maintenance history information) about the mobile body to the information generating server 107.

The maintenance terminals 105 include electronic terminals managed by the respective dealers 106. Each maintenance terminal 105 records the above predetermined maintenance information and displays, on its display unit, route information (to be described below) generated by the information generating server 107. By referring to the route information, the maintenance worker can efficiently visit the locations of mobile bodies 102 to perform maintenance work. The maintenance terminals 105 wirelessly communicate with the wireless communication base stations 103 to transmit and receive the maintenance information about mobile bodies and the route information to and from the information generating server 107.

The information generating server 107 includes a server that is an example of an information generating apparatus. The information generating server 107 obtains information (the usage state information and the location information about the mobile bodies) obtained in and transmitted from the mobile bodies 102, and the maintenance information about the mobile bodies transmitted from the maintenance terminals 105. The obtained information is recorded in a recording unit 303 in the information generating server 107. Based on the usage state information and the maintenance information about the mobile bodies, the information generating server 107 estimates the maintenance time for each mobile body. Further, based on the locations of the mobile bodies and the estimated maintenance times for the mobile bodies, the information generating server 107 generates route information for visiting the locations of the mobile bodies. The information generating server 107 transmits the generated route information to the maintenance terminals 105.

<Configuration of Mobile Body>

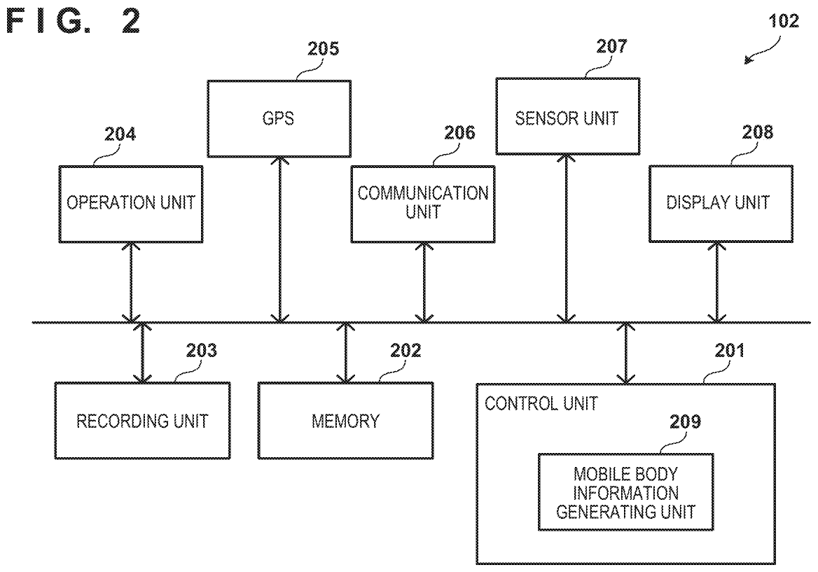

The configuration of each mobile body will be described with reference to FIG. 2. FIG. 2 shows an exemplary functional configuration of each mobile body 102 according to this embodiment. The functional blocks shown may be integrated or separated, and functions of a block to be described may be implemented by another block. What is described as hardware may be implemented as software, and vice versa.

A control unit 201 includes a CPU that is a central processing unit, and a ROM that is nonvolatile memory. The control unit 201 loads programs stored in the ROM into a memory 202 and executes the programs, thereby controlling the operation of components of the control unit 201 and controlling the operation of components of the mobile body 102. The control unit 201 also performs the process of providing mobile body information (to be described below).

The memory 202 includes a volatile storage medium, for example DRAM, and temporarily stores parameters used for executing programs by the control unit 201, processing results, and other data. A recording unit 203 includes a nonvolatile recording medium, for example semiconductor memory. The recording unit 203 records setting values necessary for the operation of the mobile body 102, as well as usage state information recorded by a mobile body information generating unit 209 in the control unit 201 and location information output from a GPS 205.

An operation unit 204 includes operation members used by the user of the mobile body 102 to provide operation instructions to the mobile body 102. The operation unit 204 receives input operations to provide operation information to the control unit 201, and to control the movement of driving parts. The operation members include a handle, a lever, buttons, and a touch-input panel, for example.

The GPS 205 is a sensor that receives signals from a satellite to obtain location information about the mobile body 102. The GPS 205 outputs the current location of the mobile body 102 represented as, for example, latitude information and longitude information.

A communication unit 206 includes a communication circuit that communicates with other apparatuses such as the information generating server 107 over the communication network 104. For example, the communication unit 206 communicates with a wireless communication base station 103 according to a standard such as LTE-Advanced to transmit and receive information to and from other apparatuses connected to the communication network 104. The communication unit 206 transmits, in response to an instruction from the control unit 201, the usage state information and the location information about the mobile body recorded in the recording unit 203 to the information generating server 107.

A sensor unit 207 includes one or more sensors, such as sensors for measuring the operation of power generation units (not shown) in the mobile body. For example, the sensor unit 207 includes a sensor for measuring the RPM of a first power generation unit (not shown, for example an engine) that causes the mobile body 102 to travel. If the mobile body 102 has a second power generation unit (not shown) that drives a member needed for the work performed by the mobile body (not shown, for example a blade of a lawn mower), the sensor unit 207 also includes a sensor for measuring the RPM of the second power generation unit. The sensor unit 207 further includes, for example, a sensor for measuring the vehicle speed of the mobile body 102, and a sensor for measuring the cumulative usage time of the mobile body 102. The sensor unit 207 outputs the measurements of the sensors to the control unit 201.

A display unit 208 includes a display panel, for example an LCD or OLED, and displays the operation states of the power generation units in the mobile body 102.

The mobile body information generating unit 209 obtains the measurement information from the sensor unit 207 and records the information as the usage state information about the mobile body in the recording unit 203. The mobile body information generating unit 209 also obtains the location information from the GPS 205 and records the information in the recording unit 203.

<Configuration of Information Generating Server>

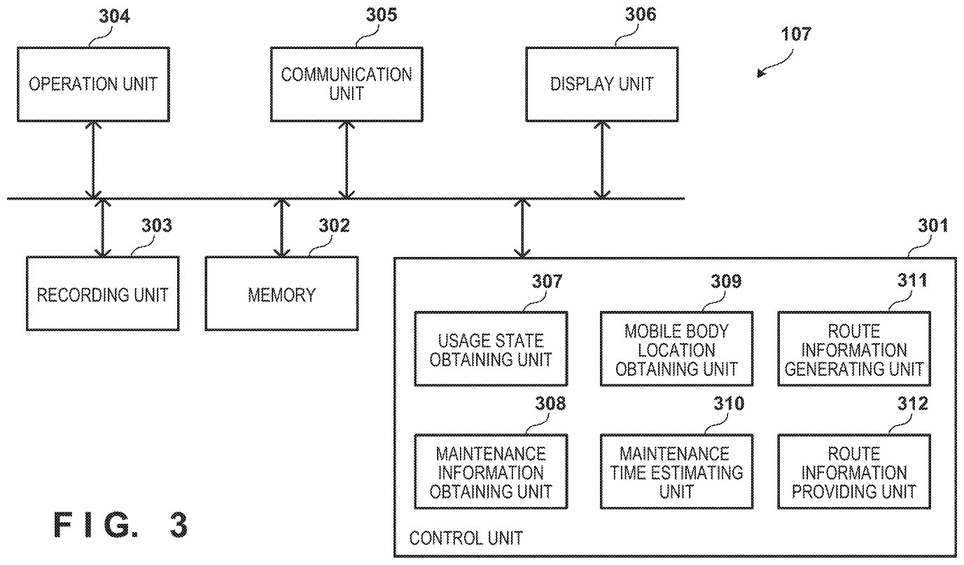

An exemplary functional configuration of the information generating server 107 will be described with reference to FIG. 3. The functional blocks shown may be integrated or separated, and functions of a block to be described may be implemented by another block. What is described as hardware may be implemented as software, and vice versa.

A control unit 301 includes a CPU that is a central processing unit, and a ROM that is nonvolatile memory. The control unit 301 loads programs stored in the ROM into a memory 302 and executes the programs, thereby controlling the operation of components of the control unit 301 and controlling the operation of components of the information generating server 107. The control unit 301 also performs the process of generating route information (to be described below).

The memory 302 includes a volatile storage medium, for example DRAM, and temporarily stores parameters used for executing programs by the control unit 301, processing results, and other data. A recording unit 303 includes a nonvolatile recording medium, for example semiconductor memory.

The recording unit 303 records setting values necessary for the operation of the information generating server 107. The recording unit 303 also records information about a mobile body information database, in which the usage state information transmitted from each mobile body and maintenance information are associated with identity information about the mobile body.

An operation unit 304 includes operation members, such as a keyboard and a mouse, used by the manager of the information generating server 107 to provide operation instructions. Upon receiving an input operation, the operation unit 304 provides operation information to the control unit 301. A communication unit 305 includes a communication circuit that communicates with the mobile bodies 102 and the maintenance terminals 105 over the communication network 104. A display unit 306 includes a display panel, for example an LCD or OLED. The display unit 306 displays, for example, a setting user interface used by the manager to configure the information generating server 107.

A usage state obtaining unit 307 obtains, via the communication unit 305, the usage state information about the mobile bodies transmitted from the mobile bodies 102. The usage state obtaining unit 307 stores the obtained information in the mobile body information database. A maintenance information obtaining unit 308 obtains, via the communication unit 305, maintenance information about the mobile bodies transmitted from the maintenance terminals 105. The maintenance terminals 105 may be different terminals used by the respective maintenance workers. As such, the maintenance information from multiple maintenance workers can be widely gathered and collectively used. The more the information can be gathered, the more accurate the estimated maintenance times can be. The maintenance information obtaining unit 308 records the obtained maintenance information in the mobile body information database.

A mobile body location obtaining unit 309 obtains, via the communication unit 305, the location information transmitted from the mobile bodies 102 and stores the location information in the mobile body information database. Based on the obtained location information about the mobile bodies 102, the mobile body location obtaining unit 309 can identify the locations of the mobile bodies 102.

A maintenance time estimating unit 310 estimates the maintenance times for the mobile bodies 102 based on the usage state information and the maintenance information about the mobile bodies recorded in the mobile body information database. For example, the maintenance time estimating unit 310 estimates the maintenance time for each of the mobile bodies recorded in the mobile body information database.

A route information generating unit 311 generates route information based on the identified location of each mobile body 102 and on the estimated maintenance time for each mobile body 102. This route information includes a route by which a maintenance worker visits the location of each mobile body.

A route information providing unit 312 causes the route information generated by the route information generating unit 311 to be transmitted to the maintenance terminals 105 via the communication unit 305.

<Configuration of Maintenance Terminal>

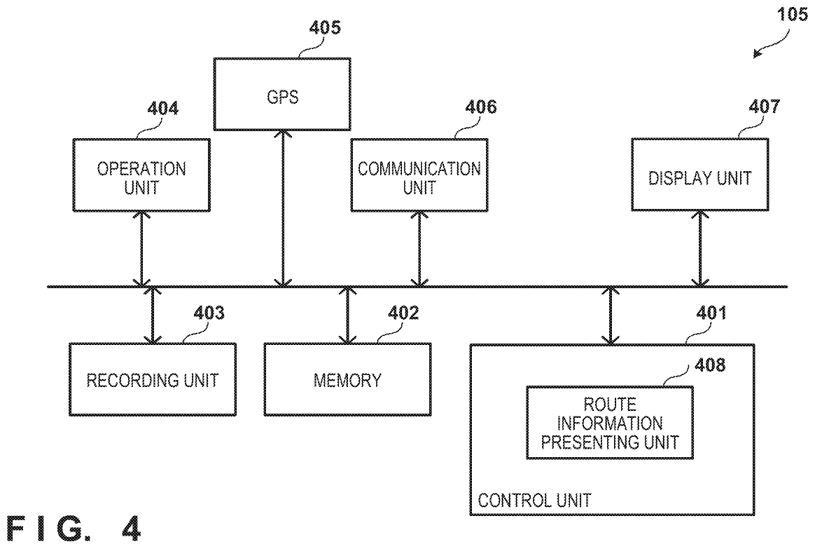

An exemplary functional configuration of each maintenance terminal 105 used by a maintenance worker will further be described with reference to FIG. 4. The functional blocks shown may be integrated or separated, and functions of a block to be described may be implemented by another block. What is described as hardware may be implemented as software, and vice versa.

A control unit 401 includes a CPU that is a central processing unit, and a ROM that is nonvolatile memory. The control unit 401 loads programs stored in the ROM into a memory 402 and executes the programs, thereby controlling the operation of components of the control unit 401 and controlling the operation of components of the maintenance terminal 105. The control unit 401 also performs the process of presenting route information via a route information presenting unit 408 (to be described below). The control unit 401 further associates data such as maintenance details input by the maintenance worker with identity information about mobile bodies subjected to the maintenance, and temporarily records the information as maintenance information (i.e., a maintenance history) about the mobile bodies in the recording unit 403.

The memory 402 includes a volatile storage medium, for example DRAM, and temporarily stores parameters used for executing programs by the control unit 401, processing results, and other data. A recording unit 403 includes a nonvolatile recording medium, for example semiconductor memory. The recording unit 403 records setting values necessary for the operation of the maintenance terminal 105, as well as maintenance information about mobile bodies.

An operation unit 404 includes operation members used by the maintenance worker to provide operation instructions to the maintenance terminal 105. The operation unit 404 receives input operations to provide operation information to the control unit 401. The operation members include a touch-input panel and buttons, for example.

A GPS 405 is a sensor that receives signals from a satellite to obtain location information about the maintenance terminal 105. The GPS 405 outputs the current location of the maintenance terminal 105 represented as, for example, latitude information and longitude information.

A communication unit 406 includes a communication circuit that communicates with other apparatuses such as the information generating server 107 over the communication network 104. For example, the communication unit 406 communicates with a wireless communication base station 103 according to a standard such as LTE-Advanced to transmit and receive information to and from other apparatuses connected to the communication network 104. The communication unit 406 transmits, in response to an instruction from the control unit 401, the maintenance information recorded in the recording unit 403 to the information generating server 107. A display unit 407 includes a display panel, for example an LCD or OLED, and displays route information in response to an instruction from the control unit 401.

In the process of presenting the route information (to be described below), a route information presenting unit 408 receives the route information from the information generating server 107 and displays the route information on the display unit 407. Thereafter, while the current location of the maintenance terminal 105 is continuously obtained, the route information presenting unit 408 may display, on the display unit 407, a guide (navigation) for visiting the location of each mobile body.

<Process of Providing Mobile Body Information in Mobile Body>

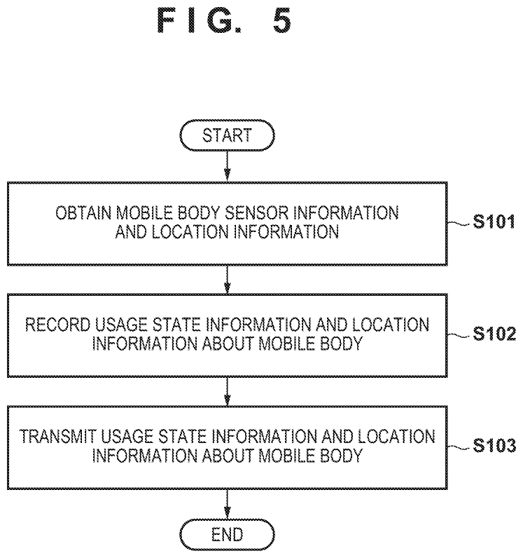

The process of providing mobile body information performed in each mobile body 102 will be described with reference to FIG. 5. In this process, processing performed by the control unit 201 and its internal functional block is implemented by the control unit 201 executing a program stored in its ROM. This process may be started upon power-on of the mobile body and repeated at predetermined time intervals.

In S101, the mobile body information generating unit 209 obtains sensor information that is output from the sensor unit 207. If the mobile body 102 is a lawn mower, the mobile body information generating unit 209 obtains, from the sensor unit 207, the above-described sensor information about the RPM of the first power generation unit, the RPM of the second power generation unit, the vehicle speed of the mobile body, and the cumulative usage time of the lawn mower, for example. If the mobile body 102 is an outboard motor, the mobile body information generating unit 209 obtains, from the sensor unit 207, the above-described sensor information about the RPM of the first power generation unit, the vehicle speed of the mobile body, and the cumulative usage time of the outboard motor, for example. The mobile body information generating unit 209 also obtains location information about the mobile body 102 from the GPS 205. Although the information is obtained on a mobile-body basis in the example described in this embodiment, this is not limiting. Rather, information on a part basis about parts forming the mobile body may be obtained and used.

In S102, the mobile body information generating unit 209 associates the obtained sensor information with identity information about the mobile body 102 and time information, and records the information as usage state information about the mobile body in the recording unit 203. The mobile body information generating unit 209 also associates the obtained location information about the mobile body 102 with the identity information about the mobile body 102 and records the information as location information in the recording unit 203.

In S103, the mobile body information generating unit 209 transmits the usage state information about the mobile body recorded in the recording unit 203 to the information generating server 107. The mobile body information generating unit 209 also transmits the location information recorded in the recording unit 203 to the information generating server 107. Although the sensor information and the location information is obtained, recorded, and transmitted at the same time in the example described in this process, these operations may be performed at discrete times.

<Process of Generating Mobile Body Information in Information Generating Server>

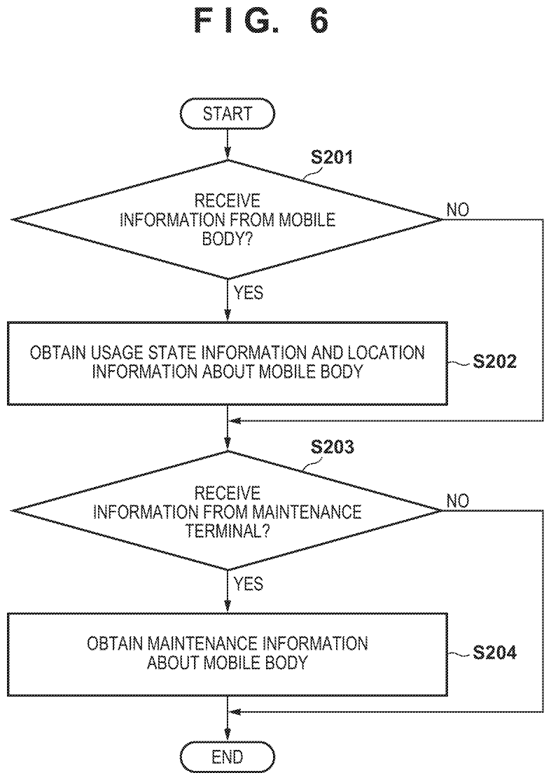

The process of generating mobile body information performed in the information generating server 107 will be described with reference to FIG. 6. In this process, processing performed by the control unit 301 and its internal functional blocks is implemented by the control unit 301 executing a program stored in its ROM.

In S201, the control unit 301 determines whether information transmitted from a mobile body 102 (that is, the usage state information and the location information about the mobile body) is received. If the information is received from a mobile body 102 via the communication unit 305, the control unit 301 advances the process to S202; otherwise, the control unit 301 advances the process to S203.

In S202, the usage state obtaining unit 307 obtains the usage state information about the mobile body received via the communication unit 305. The usage state obtaining unit 307 stores the obtained information (in association with identity information about the mobile body) in the mobile body information database. The mobile body location obtaining unit 309 also stores the received location information (in association with the corresponding identity information about the mobile body) in the mobile body information database.

In S203, the control unit 301 determines whether information transmitted from a maintenance terminal 105 (that is, the maintenance information about a mobile body) is received. If the information is received from a maintenance terminal 105 via the communication unit 305, the control unit 301 advances the process to S204; otherwise, the control unit 301 terminates the process.

In S204, the maintenance information obtaining unit 308 obtains the maintenance information about the mobile body received via the communication unit 305 and stores the obtained information (in association with identity information about the mobile body) in the mobile body information database. Once the maintenance information obtaining unit 308 stores the obtained information in the mobile body information database, the control unit 301 terminates the process.

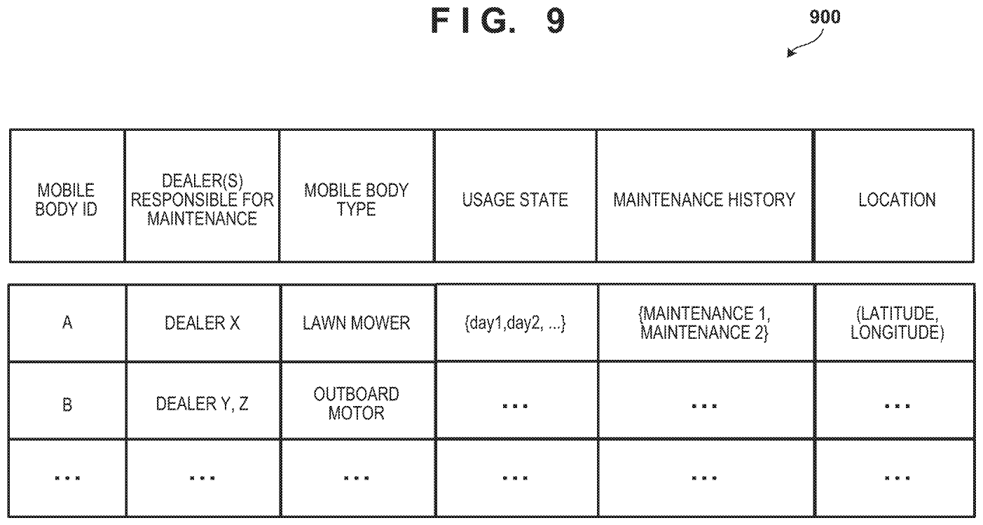

Here, the mobile body information stored in the mobile body information database will be described with reference to FIG. 9. For example, in mobile body information 900, the usage state information and the maintenance information are recorded in association with the identity information about the mobile bodies (mobile body IDs). Each item of the mobile body information includes the latest location information about a mobile body, information about one or more dealers responsible for maintenance, and information indicating the mobile body type.

The information generating server 107 performs supervised learning in order to estimate the maintenance times for the mobile bodies. The pair of the usage state information and the maintenance information about each mobile body in the mobile body information serves as labeled training data in the training performed by the information generating server 107. That is, the information about the past maintenance is used as labeled training data indicating when the maintenance should have been performed with respect to the past usage state of the mobile body. The example to be described below uses labeled training data indicating when is the optimal time for performing maintenance. In addition, data about comments from maintenance workers and users may be analyzed to use the analysis as labeled training data indicating what kind of maintenance produces a more optimal result.

The usage state information is stored for, for example, each measurement day for the mobile body. Data on each measurement day (e.g., day1) includes, for example, a change over time in the RPM of the first power generation unit (data1), a change over time in the RPM of the second power generation unit (data2), a change over time in the vehicle speed of the mobile body (data3), and a change over time in the cumulative usage time (data4). That is, data on one day includes data samples over time for four items, such that day1={data1, data2, data3, data4}. For example, data1 retrieved from data on multiple days and serialized constitutes data samples over multiple measurement days about changes in the speed of the first power generation unit.

As the maintenance information, the maintenance date and time and maintenance details are recorded for each occasion of maintenance performed by a maintenance worker. For example, this information is recorded as maintenance1={the maintenance date and time, maintenance details, the optimal maintenance time based on the deterioration state of the mobile body}. “The maintenance date and time” is information about the date and time of the maintenance. “Maintenance details” include, for example, information about the deterioration state of the mobile body and information about replaced parts. The “information about the deterioration state of the mobile body” is input by the maintenance worker at the time of maintenance. For example, this information may include various types of information, such as numerical information about graded evaluation of the deterioration state of the whole mobile body (e.g., on a 1-to-10 scale), text information describing the deterioration state, and a photo image of a specific part.

“The optimal maintenance time based on the deterioration state of the mobile body” is information set by the maintenance worker. For example, this is date information indicating a maintenance time as late as possible and capable of preventing a failure with respect to the state of the mobile body. This information provides a ground truth label for the information generating server 107 to estimate the optimal maintenance time in response to an input of the usage state information. For example, if the maintenance worker actually performs maintenance and finds a failure in the mobile body, the maintenance worker sets a date that is predetermined days (e.g., 30 days) before the day the failure occurred. If the maintenance worker actually performs maintenance and supposes that the optimal maintenance time will be 60 days after (such as because the mobile body is in good condition), the maintenance worker sets a date that is 60 days after the maintenance day.

In addition to the maintenance time set for the whole mobile body 102, the information “the optimal maintenance time based on the deterioration state of the mobile body” may include the individual optimal maintenance time set for each of the first power generation unit and the second power generation unit.

In the example of the mobile body with the mobile body ID “A” shown in FIG. 9, maintenance1 and maintenance2 were performed in the past. The information generating server 107 can then use data about a period 1 from the time of purchase to maintenance1, and a period 2 from maintenance1 to maintenance2. For example, for the usage state information obtained in the period 1 (the data set of data1 to data4), “the optimal maintenance time based on the deterioration state of the mobile body” recorded in maintenance1 gives the ground truth. For the usage state information obtained in the period 2 (the data set of data1 to data4), “the optimal maintenance time based on the deterioration state of the mobile body” recorded in maintenance2 gives the ground truth.

<Process of Generating Route Information in Information Generating Server>

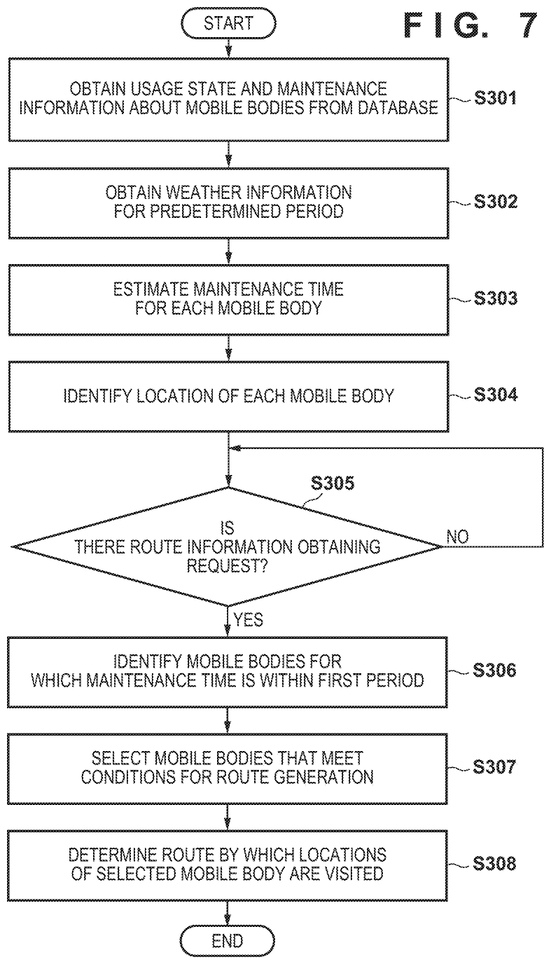

The process of generating route information performed in the information generating server 107 will be described with reference to FIG. 7. In this process, processing performed by the control unit 301 and its internal functional blocks is implemented by the control unit 301 executing a program stored in its ROM.

In S301, the control unit 301 obtains the usage state information and the maintenance information about mobile bodies from the mobile body information database recorded in the recording unit 303. For example, the control unit 301 obtains, from the database, information about many mobile bodies to which supervised learning is to be applied using, for example, deep learning.

In S302, the control unit 301 obtains past weather information for a predetermined period from an external weather-information database server (not shown). The control unit 301 additionally has a weather information obtaining unit (not shown), with which the control unit 301 obtains the weather information.

In S303, the control unit 301 estimates the maintenance time for each mobile body. Specifically, first, the maintenance time estimating unit 310 trains a neural network that takes, as an input, usage state information about a mobile body and outputs a maintenance time. For example, a neural network (simply referred to as an N-network) having multiple hidden layers is used here. At the start of training, the N-network initializes the weight on the N-network to a random value.

For example, a piece of input data obtained from one mobile body (e.g., the usage state information for the period up to maintenance1) is given as an input to the N-network, which then outputs an estimated maintenance time as a result. The weight on the N-network is adjusted so that this estimated result approaches the correct maintenance time obtained from the maintenance information (e.g., “the optimal maintenance time based on the deterioration state of the mobile body” recorded in maintenance1). This process is repeated for multiple pieces of input data about many mobile bodies to converge the weight on the N-network to an optimal value (that is, make the N-network trained). The trained N-network can now output, in response to input data not learned in the training (e.g., usage state information obtained after maintenance2), a maintenance time estimated from the input data.

The maintenance time estimating unit 310 then inputs the most recent usage state information about a mobile body (for the period from the last maintenance to the present) to the trained N-network to estimate a future maintenance time. The maintenance time estimating unit 310 performs this process for each mobile body to estimate the maintenance time for the mobile body. If the optimal maintenance time for each power generation unit is recorded in the maintenance history, the maintenance time for the first power generation unit and the maintenance time for the second power generation unit are estimated in addition to the maintenance time for each mobile body.

At this point, the maintenance time estimating unit 310 may correct, based on the weather information obtained in S302, the maintenance time determined for each mobile body. For example, if the mobile body is a ship, the maintenance time may be advanced by a predetermined period if the number of occurrences of bad weather in the period from the last maintenance to the present is above a predetermined number. By contrast, the maintenance time may be postponed by a predetermined period if the number of occurrences of bad weather is below a predetermined number. In this manner, possible damage to the outboard motor due to, for example, high waves can be taken into account even if the mobile body is estimated to deteriorate slowly from the usage state information.

As another example, if the mobile body 102 is a lawn mower, the degree of deterioration of the lawn mower may change due to seasonal variations in the amount of grass and in the degree of rust formation. As such, for example, if it is determined that the period from the last maintenance to the present is winter based on the temperature and rainfall in the weather information, the maintenance time estimating unit 310 may postpone the maintenance time by a predetermined period. By contrast, if it is determined that the period from the last maintenance to the present is summer based on the temperature and rainfall in the weather information, the maintenance time estimating unit 310 may advance the maintenance time by a predetermined period. If the period from the last maintenance to the present is spring or autumn, the maintenance time may be unchanged. In this manner, deterioration of the lawn mower estimated from the usage state information can take into account, for example, the influence of the grass condition or the degree of rust formation on the lawn mower.

In S304, the mobile body location obtaining unit 309 obtains the location information about each mobile body 102 recorded in the recording unit 303 and identifies the location of the mobile body based on the obtained location information and map information.

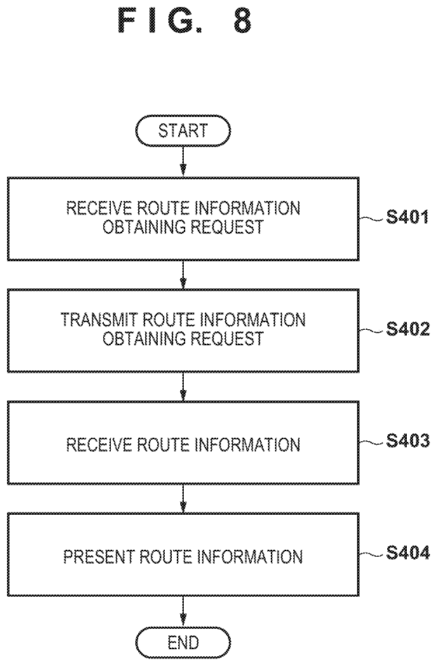

In S305, the control unit 301 determines whether a route information request is received from a maintenance terminal 105. If it is determined that the route information obtaining request is received, the control unit 301 advances the process to S306; otherwise, the control unit 301 returns to S305 to wait for the route information obtaining request. As will be described in FIG. 8, the route information request may include dealer identity information and the current location of the maintenance terminal 105. The route information request may further include conditions for mobile bodies to be addressed in the route information. For example, the conditions for mobile bodies to be addressed in the route may specify a particular mobile body type and particular maintenance details.

In S306, the route information generating unit 311 identifies mobile bodies for which the maintenance time estimated in S303 is within a first period (e.g., next three months). That is, the route information generating unit 311 identifies mobile bodies for which the maintenance time is estimated to come soon.

In S307, the route information generating unit 311 further selects, among the mobile bodies identified in S306, mobile bodies that meet conditions for route generation. For example, the route information generating unit 311 refers to the dealer identity information recorded in the mobile body information database to select the mobile bodies maintained by the maintenance worker that has transmitted the route information obtaining request.

The route information generating unit 311 may also select mobile bodies 102 that require the same kind of maintenance. For example, if the maintenance time for the first power generation unit and the maintenance time for the second power generation unit have been estimated and the first power generation unit is designated in the received route information request, only mobile bodies in which the first power generation unit is to be maintained are selected. In this manner, in visiting mobile bodies, the maintenance worker can visit, at a time, mobile bodies that require the same kind of maintenance. This increases the maintenance efficiency because, for example, the maintenance worker only has to bring particular replaceable parts.

The route information generating unit 311 may also select mobile bodies located in the area where the maintenance terminal 105 is currently located and each having the minimum distance to another mobile body shorter than a predetermined distance. In this manner, the maintenance worker can visit, at a time, mobile bodies close to each other.

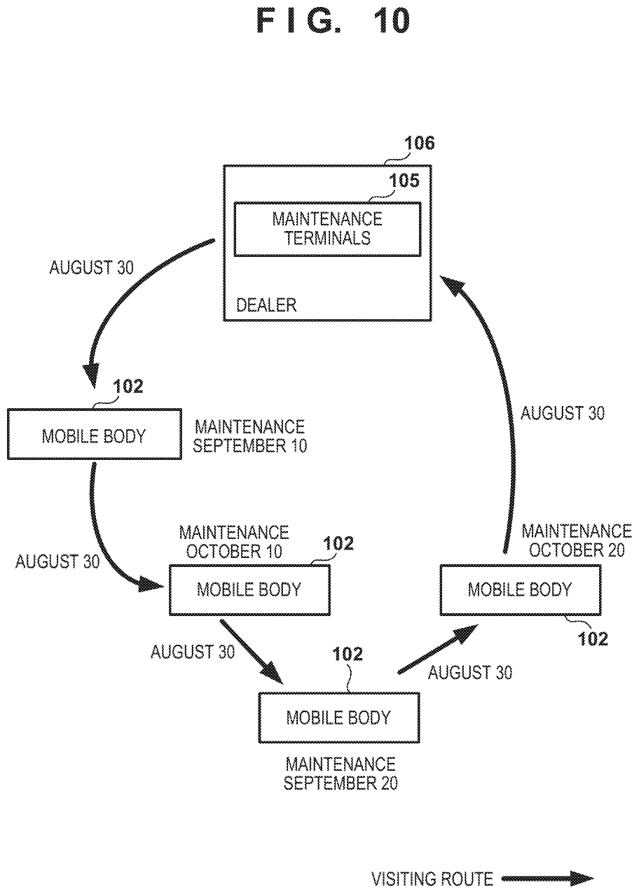

In S308, the route information generating unit 311 determines a route by which the locations of the mobile bodies 102 selected in S307 are visited in a second period (e.g., one day). The second period here is shorter than the above-mentioned first period. That is, the mobile bodies having their respective maintenance times within the first period (e.g., the next three months) can be visited at a time in the second period, so that the maintenance worker can more efficiently visit the locations of the mobile bodies. FIG. 10 schematically shows an exemplary route by which the maintenance worker visits the locations of the mobile bodies. Mobile bodies 102 shown in FIG. 10 have their respective maintenance times within a period from September 10 to October 20. The determined route (shown by arrows) indicates a route by which the locations of the mobile bodies 102 are visited at a time on August 30. For example, the route information generating unit 311 determines the optimal route that minimizes the distance to be driven for visiting the locations of the mobile bodies.

The route information generating unit 311 generates route information based on the determined route. For example, the route information is a combination of information about the locations to be visited and information about the mobile bodies to be maintained, listed in the order of visiting. The control unit 301 transmits the route information including the determined route to the maintenance terminal 105. The control unit 301 then terminates the process.

<Process of Presenting Route Information in Maintenance Terminal>

Further, the process of presenting the route information in a maintenance terminal 105 will be described with reference to FIG. 8. In this process, processing performed by the control unit 401 and its internal functional block is implemented by the control unit 401 executing a program stored in its ROM.

In S401, the control unit 401 receives a route information obtaining request, which is an operation instruction from a maintenance worker. Specifically, the control unit 401 presents a route information presentation application on the display unit 407 and receives, via the operation unit 404, the maintenance worker's operation of pressing a “Get Route Information” button on the application.

In S402, the control unit 401 transmits the route information obtaining request to the information generating server 107 via the communication unit 406. The route information obtaining request transmitted to the information generating server 107 may include, for example, dealer identity information and the current location of the maintenance terminal 105. The request may further designate conditions for mobile bodies to be addressed in the route information. The conditions for mobile bodies to be addressed in the route may specify, for example, a particular mobile body type and particular maintenance details. For example, these conditions are taken into account in above-described S307 in the information generating server 107. The request may also designate the above-mentioned second period. This period specifies a particular day, or a period such as from xx (month)/yy (day) to xx (month)/zz (day).

In S403, the control unit 401 receives route information from the information generating server 107. The route information is generated by the information generating server 107 in the above-described process of generating route information.

In S404, the control unit 401 presents the route information on the display unit 407. Specifically, the route information presenting unit 408 maps the route information received from the information generating server 107 onto map information, and as necessary, displays roads to be driven. After presenting the route information, the control unit 401 terminates the process. Additionally, after a visit plan is agreed upon with the owners of the mobile bodies 102, the control unit 401 may provide a guide (navigation) function along the route.

As described above, in this embodiment, the maintenance time for each mobile body is estimated based on usage state information and maintenance information obtained. Based on the locations of the mobile bodies and the estimated maintenance times for the mobile bodies, a route is determined by which a worker responsible for the maintenance of the mobile bodies visits the locations of the mobile bodies, and route information including the route is generated. This enables generating information with which a worker responsible for maintenance work can more efficiently visit the locations of mobile bodies.

The example described in this embodiment involves generating labeled training data using “the optimal maintenance time based on the deterioration state of the mobile body.” Alternatively, labeled training data may be generated without using “the optimal maintenance time based on the deterioration state of the mobile body.” For example, graded evaluation of “the deterioration state of the mobile body” may be used to generate labeled training data for estimating the deterioration state of each mobile body in response to an input of usage state information. In this case, the control unit 301 uses an N-network to estimate the graded evaluation of the deterioration state based on the usage state information. The control unit 301 then obtains (e.g., using a predetermined table) the maintenance time with respect to the estimated graded evaluation of the deterioration state.

Further, if “the deterioration state of the mobile body” is used, an image shot at the time of maintenance or text that is input by the maintenance worker may be used instead of the value of graded evaluation. In this case, a separate N-network that estimates the deterioration state in response to the content of an input image or text is used for the estimation process. Then, labeled training data that combines the usage state information about each mobile body and the estimated deterioration state is used. The control unit 301 uses the N-network to estimate the deterioration state of each mobile body based on the usage state information, and obtains (e.g., using a predetermined table) the maintenance time with respect to the estimated deterioration state.

In the above example in S308, the route information is generated such that the mobile bodies for which the maintenance time estimated in S303 is within the first period (e.g., the next three months) are visited in the second period included in the first period (one day in the next three months). Alternatively, the mobile bodies for which the estimated maintenance time is within the first period (e.g., from three months after to six months after) may be visited in the second period before the first period (one day in the next three months). For example, if the estimated maintenance times for the mobile bodies are within the first period in which the frequency of use of the mobile bodies will increase, the route information may be generated such that the mobile bodies are visited in the second period set before the first period. For example, if the mobile bodies are lawn mowers, the period from June to August may be a predetermined period in which the frequency of use will increase. If the maintenance times for the lawn mowers estimated in S303 are within this period from June to August, a route may be generated such that the locations of the lawn mowers are visited in the second period (one day in a period before June). In this manner, the users (or owners) of the mobile bodies can subject their mobile bodies to maintenance before the demand for using the mobile bodies increases. That is, this can reduce the possibility that the mobile bodies cannot be used (due to the occurrence of failures) in a season with high demand for use.

In the example described in the above embodiment, the process of generating the mobile body information and the process of generating the route information are performed in the information generating server 107. Alternatively, these processes may be performed in the maintenance terminals 105.

The present invention is not limited to the above embodiment but encompasses various modifications and variations without departing from the spirit and scope of the present invention. The following claims are thus appended in order to make the scope of the present invention public.

### Summary of Embodiment

1. An information generating apparatus (e.g., 107) in the above embodiment includes: a usage state obtaining unit (e.g., the usage state obtaining unit 307) configured to obtain usage state information about mobile bodies from the mobile bodies; a maintenance information obtaining unit (e.g., the maintenance information obtaining unit 308) configured to obtain maintenance information about the mobile bodies; an estimating unit (e.g., the maintenance time estimating unit 310) configured to estimate a maintenance time for each mobile body based on the usage state information and the maintenance information; a determining unit (e.g., the route information generating unit 311) configured to determine, based on locations of the mobile bodies and the maintenance time estimated for each mobile body, a route by which a worker responsible for maintenance of the mobile bodies visits the locations of the mobile bodies; and a generating unit (e.g., the route information generating unit 311) configured to generate route information including the route determined.

According to this embodiment, information for the worker responsible for maintenance work to more efficiently visit the locations of the mobile bodies can be generated.

2. In the above embodiment, the determining unit (e.g., the route information generating unit 311) determines the route such that locations of mobile bodies for which the maintenance time estimated is within a first period are visited by the worker in a second period shorter than the first period.

According to this embodiment, the maintenance worker can visit, at a time, mobile bodies for which the maintenance time will come soon.

3. In the above embodiment, the determining unit (e.g., the route information generating unit 311) determines the route for mobile bodies requiring the same kind of maintenance, among the mobile bodies for which the maintenance time estimated is within the first period.

According to this embodiment, in visiting mobile bodies, the maintenance worker can visit, at a time, mobile bodies that require the same kind of maintenance. This increases the maintenance efficiency because, for example, the maintenance worker only has to bring particular replaceable parts.

4. In the above embodiment, the determining unit (e.g., the route information generating unit 311) determines the route for mobile bodies each having a minimum distance to another mobile body shorter than a predetermined distance, among the mobile bodies for which the estimated maintenance time is within the first period.

According to this embodiment, the maintenance worker can visit, at a time, mobile bodies close to each other. This increases the maintenance efficiency.

5. In the above embodiment, in a case where the maintenance time estimated for each mobile body is within the first period in which a frequency of using the mobile bodies increases, the determining unit (e.g., the route information generating unit 311) determines the route such that the locations of the mobile bodies are visited by the worker in the second period set before the first period.

According to this embodiment, the users (or owners) of the mobile bodies can subject their mobile bodies to maintenance before the demand for using the mobile bodies increases. That is, this can reduce the possibility that the mobile bodies cannot be used (due to the occurrence of failures) in a season with high demand for use.

6. The above information generating apparatus further includes a weather information obtaining unit (S303) configured to obtain weather information, wherein the estimating unit estimates the maintenance time for each mobile body further based on the weather information obtained (S303).

According to this embodiment, deterioration of the mobile bodies estimated from the usage state information can take into account, for example, the influence of high waves on outboard motors, or the influence of the grass condition or the degree of rust formation on lawn mowers.

7. In the above embodiment, the maintenance information obtaining unit (e.g., the maintenance information obtaining unit 308) obtains the maintenance information from different electronic terminals used by respective workers responsible for maintenance of the mobile bodies.

According to this embodiment, the maintenance information from multiple maintenance workers can be widely gathered and collectively used. The more the information can be gathered, the more accurate the estimated maintenance times can be.

8. In the above embodiment, the mobile bodies include working machines.

According to this embodiment, working machines including lawn mowers and snowplows, for example, can be visited and maintained.

9. A method of controlling an information generating apparatus (e.g., 107) described above includes: obtaining, by a maintenance information obtaining unit, maintenance information about the mobile bodies from the mobile bodies (e.g., S202); obtaining, by a maintenance information obtaining unit, maintenance information about the mobile bodies (e.g., S204, S301); estimating, by an estimating unit, a maintenance time for each mobile body based on the usage state information and the maintenance information (e.g., S303); determining, by a determining unit, based on locations of the mobile bodies and the maintenance time estimated for each mobile body, a route by which a worker responsible for maintenance of the mobile bodies visits the locations of the mobile bodies (e.g., S306-S308); and generating, by a generating unit, route information including the route determined (e.g., S308).

According to this embodiment, information for the worker responsible for maintenance work to more efficiently visit the locations of the mobile bodies can be generated.

What is claimed is:

1. An information generating apparatus comprising:
one or more processors; and
a memory storing instructions which, when the instructions are executed by the one or more processors, cause the image processing apparatus to function as:
a usage state obtaining unit configured to obtain usage state information about mobile bodies from the mobile bodies;
a maintenance information obtaining unit configured to obtain maintenance information about the mobile bodies;
an estimating unit configured to estimate a maintenance time for each mobile body based on the usage state information and the maintenance information;
a determining unit configured to determine, based on locations of the mobile bodies and the maintenance time estimated for each mobile body, a route by which a worker responsible for maintenance of the mobile bodies visits the locations of the mobile bodies; and
a generating unit configured to generate route information including the route determined,
wherein the determining unit specifies the mobile bodies of which the worker visits the locations based on whether the maintenance time estimated is within a first period.

2. The information generating apparatus according to claim 1, wherein the determining unit determines the route such that locations of mobile bodies for which the maintenance time estimated is within the first period are visited by the worker in a second period shorter than the first period.

3. The information generating apparatus according to claim 2, wherein the determining unit determines the route for mobile bodies requiring the same kind of maintenance, among the mobile bodies for which the maintenance time estimated is within the first period.

4. The information generating apparatus according to claim 2, wherein the determining unit determines the route for mobile bodies each having a minimum distance to another mobile body shorter than a predetermined distance, among the mobile bodies for which the maintenance time estimated is within the first period.

5. The information generating apparatus according to claim 2, wherein, in a case where the maintenance time estimated is within the first period in which a frequency of using the mobile bodies increases, the determining unit determines the route such that the locations of the mobile bodies are visited by the worker in the second period set before the first period.

6. The information generating apparatus according to claim 1, further comprising a weather information obtaining unit configured to obtain weather information, wherein
the estimating unit estimates the maintenance time for each mobile body further based on the weather information obtained.

7. The information generating apparatus according to claim 1, wherein the maintenance information obtaining unit obtains the maintenance information from different electronic terminals used by respective workers responsible for maintenance of the mobile bodies.

8. The information generating apparatus according to claim 1, wherein the mobile bodies comprise working machines.

9. A method of controlling an information generating apparatus, the method comprising:
obtaining, by a usage state obtaining unit, usage state information about mobile bodies from the mobile bodies;
obtaining, by a maintenance information obtaining unit, maintenance information about the mobile bodies;
estimating, by an estimating unit, a maintenance time for each mobile body based on the usage state information and the maintenance information;
determining, by a determining unit, based on locations of the mobile bodies and the maintenance time estimated for each mobile body, a route by which a worker responsible for maintenance of the mobile bodies visits the locations of the mobile bodies; and
generating, by a generating unit, route information including the route determined,
wherein the determining the route comprises specifying the mobile bodies of which the worker visits the locations based on whether the maintenance time estimated is within a first period.
